(19) United States
(12) Patent Application Publication
(10) Pub. No.: US 2025/0033075 A1
(43) Pub. Date: Jan. 30, 2025

(54) SPRAY NOZZLE

(71) Applicant: Spray Nozzle Engineering Pty. Ltd., Mentone (AU)

(72) Inventor: Sean MORGAN, Mentone (AU)

(21) Appl. No.: 18/791,845

(22) Filed: Aug. 1, 2024

Related U.S. Application Data
(63) Continuation of application No. 17/419,148, filed on Jun. 28, 2021, now abandoned.

(30) Foreign Application Priority Data
Dec. 28, 2018 (AU) 2018904960

(51) Int. Cl. B05B 15/18; A23C 1/04; B01D 1/18; B05B 15/50; F26B 3/12; F26B 21/00

(52) U.S. Cl. CPC B05B 15/18; A23C 1/04; B01D 1/18; B05B 15/50; F26B 3/12; F26B 21/004

(57) ABSTRACT

A removable insert and a spray nozzle which includes the removable insert and a nozzle cap. The removable insert has a base member and a protruding member. The nozzle cap has an annular flange which delimits an interior locating surface for the insert. The flange extends radially and ends with an internal extremity which defines a planar spray opening. When in use, the base member is housed within the nozzle cap whilst the protruding member projects outwardly and stands proud of the planar spray opening.

### TECHNICAL FIELD

The present invention broadly relates to a spray nozzle. More particularly, the present invention relates to a spray nozzle with an improved insert (which is often generally referred to as an orifice disc) and nozzle cap combination.

### BACKGROUND OF THE INVENTION

Spray drying of milk or dairy products involves the spraying of a milk concentrate through a pressure atomizing nozzle at a very high pressure, typically 200-500 BarG, into a heated cyclonic drying chamber operating at inlet temperatures around 120 to 160 degrees Celsius where the spray nozzle operates. These drying temperatures coupled with the atomized liquid, which in turn dries into fine particulates, produces a suspended milk powder which slowly travels to the base of the cyclone as it cools to an outlet temperature of around 60 degrees Celsius and subsequently gets collected and bagged.

Some atomized liquid, prior to being fully dried, quite often settle upon all over the surfaces of atomizing nozzles due to their close proximity to the spray orifice (ie. the outlet). Spray nozzles that currently exist in the marketplace have a shortcoming in that they are susceptible to allowing a slow accumulation of the atomised but semi-dried liquid on and around the spray orifice which resides in the hotter portion of the drier. Over time, this liquid not only dries but slowly cooks on the hot nozzles' surface. This leads to layer upon layer of build-up until a mass of cooking product develops enough accumulated heat to begin to burn. This accumulation of burnt product can slowly liberate into the properly dried cooler clean powder which results in contamination thereof with burnt particulates known as “scorched particles”. The level of scorched particles is routinely measured in the collected powder and the result forms part of a powder grading process. A high measure of scorched particles would naturally result in downgrading of the powder thereby significantly effecting its market value.

A further problem associated with the operation of the drier is that the combination of the chamber temperature and the suspended powder produced from the dried atomized liquid, poses a significant fire risk by creating and developing a source of ignition over time. This source of ignition is caused by the previously described atomized liquid settling upon and around the surfaces of the hot atomizing nozzles, accumulating thereupon, and eventually drying and cooking into a mass of cooked product with enough accumulated heat to begin to burn. Whenever build-ups occur or are expected to occur with currently existing nozzles, operators often need to prematurely shut down the drier in order to avoid build-ups from developing into an explosive ignition source that can potentially cripple the drier leading to days of down time or production outage, or worse still, a total loss of the drier plant to a fire that could not be controlled or contained. Such a need for premature shutdowns significantly impacts on the day by day productivity of the drier.

It is important to note that the spray nozzles referred to above face the challenge of operating in very high pressures. They require pressure integrity that relies upon a minimum material thickness and profiles at the end of the nozzle cap that retains the metering wear parts, to withstand the stress and strain of this pressure. Typically this required thickness intrudes into the spray zone and can interact with the spray plume, thus contributing to the build-up of the spray product upon the nozzle cap. Hence there is a need to maintain or enhance the pressure integrity of spray nozzles thereby allowing higher operating pressures and thus higher flow and greater productivity, while reducing the build-up that can occur from thicker and stronger nozzle caps. The problem is that such thicker and stronger nozzle caps which are typically adopted in the prior art in an effort to increase pressure strength would result in further intruding into the spray plume and worsening the build-up, product contamination and fire risk.

It is therefore an object of the present invention to provide a spray nozzle with an insert which may meet the above need, and/or which may overcome or ameliorate the above shortcoming and problem, or which will at least provide a useful alternative.

### SUMMARY OF THE INVENTION

According to one aspect of the present invention, there is provided a spray nozzle including:
a removable insert having a base member and a protruding member;
a nozzle cap with an annular flange which delimits an interior locating surface for the insert, the flange extending radially and ending with an internal extremity which defines a planar spray opening; and
wherein when in use, the base member is housed within the nozzle cap whilst the protruding member projects outwardly and stands proud of the planar spray opening.

Preferably, the spray nozzle includes a nozzle body to which the nozzle cap is adapted to engage, the nozzle body having fluid receiving and discharging sections and defining a counterbore which extends between the fluid receiving section and the fluid discharging section and which delineates a central axis towards which the flange radially extends.

Preferably, the protruding member includes a cylindrical wall which defines a passage which ends with an orifice. More preferably, the planar spray opening is on a plane which is substantially perpendicular to the passage.

Preferably, the protruding member of the insert is adapted to be removably fitted into the spray opening. More preferably, the protruding member has an exposed surface which travels beyond the planar spray opening. Even more preferably, the exposed surface includes an annular plateau which surrounds the orifice. Most preferably, the orifice being located at a distal end of the protruding member is distanced from the planar spray opening.

It is preferred that the annular flange also has an exterior surface which curves towards the extremity.

In one preferred embodiment, the insert is in the form of a frustoconically shaped disc. Preferably, the exposed surface is linear and tapered being inclined to the planar spray opening at a constant angle. More preferably, the base member also has a tapered external face which is linear and inclined to the planar spray opening at the same constant angle. As such, the exposed surface of the protruding member and the tapered external face of the base member are collinear and continuously integrated into one another. Preferably, the exposed surface of the protruding member and the tapered external face of the base member are also coplanar. In this embodiment, the interior locating surface of the annular flange is a slanting surface complementary to the tapered external face of the base member. As such, the tapered external face of the base member is capable of facilitating smooth insertion of the protruding member into the spray opening of the nozzle cap resulting in self, alignment or centring of the insert which is concentric or coaxial to the annular flange of the nozzle cap.

In another preferred embodiment, the interior locating surface of the annular flange is flush with the planar spray opening. The base member, being in the form of a disc, is preferred to provide an annular shoulder with an external face which in use abuts the interior locating surface. Preferably, the exposed surface converges curvedly to form a neck-shaped protruding member. In this embodiment, the spray nozzle has a downstream end portion with a smooth exterior contour which transitions from a curved exterior surface of the annular flange to the curved exposed surface of the protruding member at the extremity in a seamless fashion.

Preferably, the external face of the base member includes a groove adapted to receive a sealing means. More preferably, the sealing means is an O-ring.

Preferably, the counterbore is defined by a cylindrical wall which ends with a retaining lip which, acts as an impediment to keep, the insert in place. More preferably, the spray nozzle includes: a swirl unit which is positioned upstream of the insert. Even more preferably, the nozzle cap has an upstream end which, in use is adapted to engage the fluid receiving section, of the nozzle body. Most preferably, the nozzle cap provides a mechanism for positively securing the insert and swirl unit; in place and compresses the sealing means, as the upstream end threadably engages the fluid receiving section of the nozzle body. The arrangement is such that tightening of the nozzle cap to the nozzle body causes compressive sealing by the sealing means.

According to one aspect of the present invention, there is provided an removable insert for fitting into a nozzle cap of a spray nozzle, the insert having a base member and a protruding member which is integrated with the base member, the nozzle cap having a downstream end with an annular flange which delimits an interior locating surface for the insert, the flange extending radially towards the central axis and ending with an extremity which defines a planar spray opening; the spray nozzle including a nozzle body having fluid receiving and discharging sections and defining a counterbore which extends between the fluid receiving section and the fluid discharging section and which delineates a central axis;
wherein when in use, the base member is housed within the nozzle cap and the protruding member projects outwardly and stands proud of the planar spray opening.

### BRIEF DESCRIPTION OF THE DRAWINGS

The invention in its various aspects will now be described in connection with non-limiting embodiments described in connection with the drawings, in which:

FIG. 1 is a cross sectional view of a spray nozzle with one preferred embodiment of an insert, the spray nozzle being threadably connected to a coupling;

FIG. 2 is a perspective cross sectional view illustrating the insert of FIG. 1 coupled to a nozzle cap;

FIG. 3 is a perspective view of the spray nozzle of FIG. 1. showing the protruding member of the insert of FIG. 1. protruding from and standing proud of the spray opening; defined by the nozzle cap;

FIG. 4. Is a cross-sectional view of a spray nozzle with another preferred embodiment of the insert, the spray nozzle being threadably connected to a coupling;

FIG. 5 is perspective cross sectional view illustrating the insert of FIG. 4 coupled with a nozzle cap; and

FIG. 6 is a perspective view showing the protruding member of the insert of FIG. 4 protruding from and standing proud of the spray opening defined by the nozzle cap of FIG. 5.

### DETAILED DESCRIPTION OF THE DRAWINGS

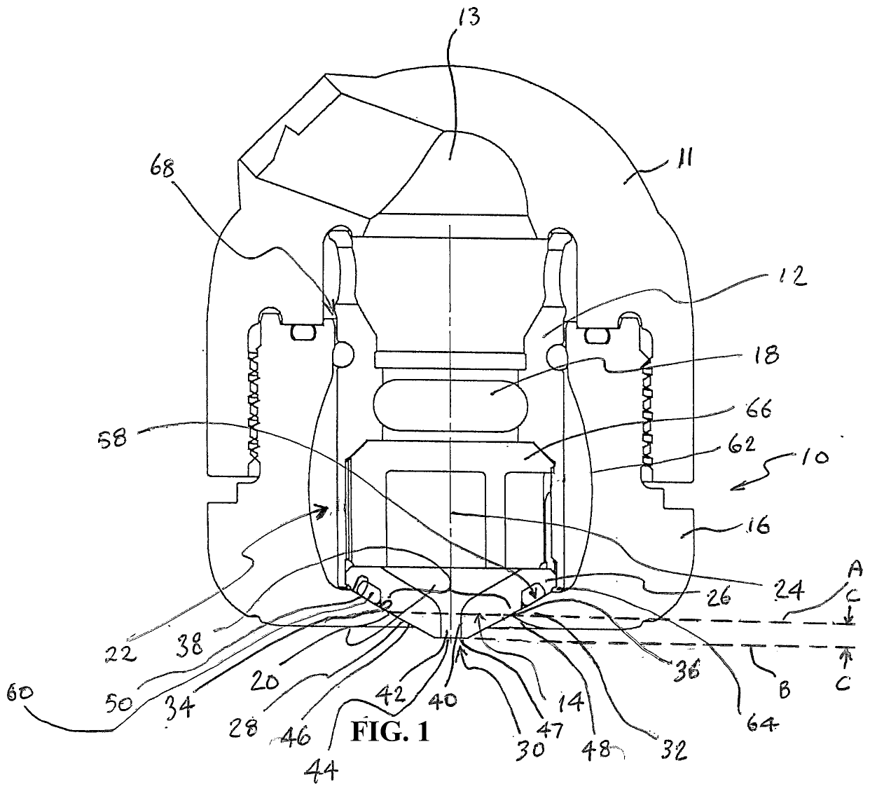

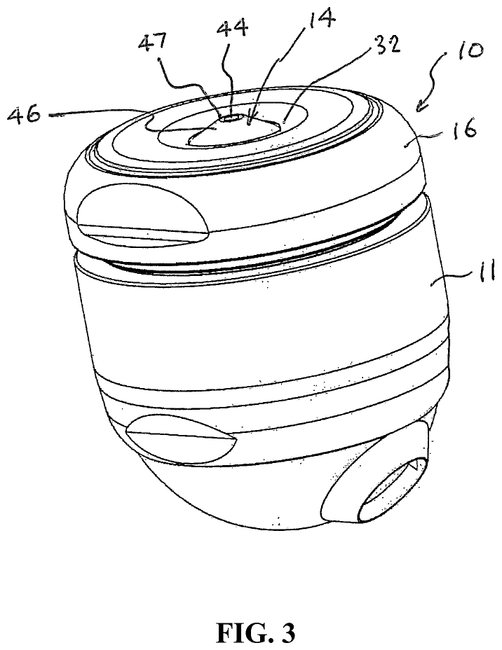

Referring to FIGS. 1, 2 and 3, a first preferred embodiment of a spray nozzle 10 is shown being threadably connected to a coupling 11 with a cavity 13 adapted to accommodate part of a spray lance (not shown). The spray nozzle 10 has among other components, a nozzle body 12, a removable insert 14 and a nozzle cap 16. The nozzle body 10 has a fluid receiving section 18 and a fluid discharging section 20. The nozzle body 10 also defines a counterbore 22 which extends between the fluid receiving section 18 and the fluid discharging section 20 and which delineates a central axis 24.

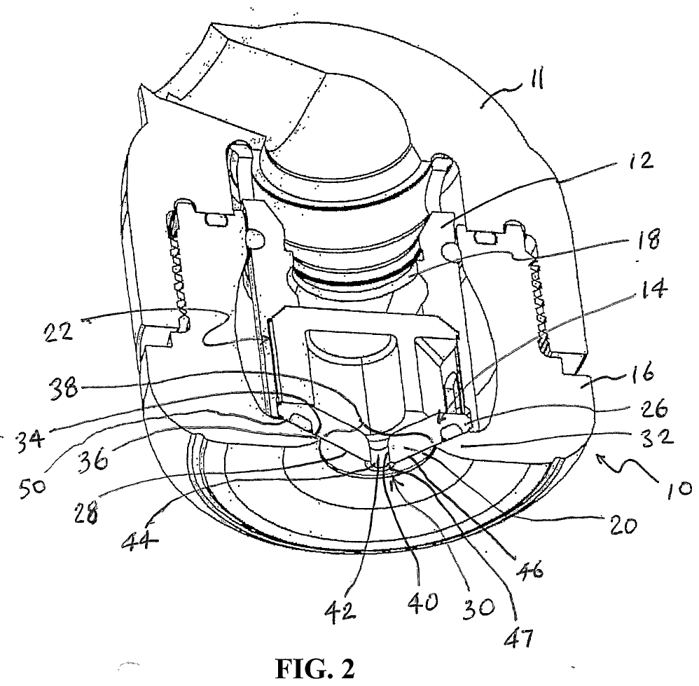

As best shown in FIGS. 1 and 2, the removable insert 14 has a base member 26 and a protruding member 28 which is integrated with the base member 26. The nozzle cap 16 has a downstream end 30 with an annular flange 32 which delimits an interior locating surface 34 for the insert 14. The annular flange 32 extends radially towards the central axis 24 and ends with an internal annular extremity 36 which defines a planar spray opening 38. When in use, the base member 26 is housed within the nozzle cap 16 whereas the protruding member 28 projects outwardly and stands proud of the planar spray opening 38. The protruding member 28 has a cylindrical wall 40 which defines a passage 42 which ends with an orifice 44. It will be appreciated that the planar spray opening 38 is on an imaginary plane A as indicated by the dotted line. The imaginary plane A is substantially perpendicular to the passage 42.

Referring to FIGS. 1 and 2, the protruding member 28 of the insert 14 is configured so as to be snugly and removably fitted into the planar spray opening 38. The protruding member 28 has an exposed surface 46 which travels beyond the planar spray opening 38. As such, the orifice 44 being located at a distal end of the protruding member 28 is distanced from the planar spray opening 38. With the orifice 44 being sufficiently raised above and beyond the planar spray opening 38 or the imaginary plane A), it will be appreciated that the spray plume (not shown) projecting out of the orifice 44 is further and substantially distanced from the % pray opening 38 and indeed the nozzle cap 16. This offers the major benefit of significantly reducing deposit and build-up of atomized liquid upon and around all of the surfaces at and around the downstream end of the protruding member 28 and the nozzle cap 16 in general. The annular flange 32 also has an exterior surface 48 which curves towards the extremity 36.

As shown in FIGS. 1 and 2, in this embodiment, the insert 14 is in the form of a frustoconically shaped disc. The exposed surface 46 is linear and tapered being inclined to the planar spray opening 38 at a constant angle. The exposed surface 46 ends with an annular plateau 47 which surrounds the orifice 44. The annular plateau 47 is parallel to an imaginary plane indicated by dotted line B. The base member 26 also has a tapered external face 50 which is also linear and inclined to the planar spray opening 38 at the same constant angle. As such, the exposed surface 46 of the protruding member 28 and the tapered external face 50 of the base member 26 are collinear, coplanar and continuously integrated into one another. Such a continuous uninterrupted surface, being a combination of the exposed surface 46 and the tapered external face 50, offers the benefit of enabling a smooth and natural engagement of the frustoconically shaped disc with the annular flange 32 with the protruding member 28 protruding way past the planar spray opening 38. In the present embodiment, the interior locating surface 34 of the annular flange 32 is a slanting; surface complementary to the tapered external face 50 of the base member 26. As such, the tapered external face 50 of the base member 28 capable of facilitating smooth insertion of the protruding member 25 into, the spray opening 38 of the nozzle cap 16 resulting in self-alignment or centering of the insert 14 which is concentric or coaxial to the annular flange 32 of the nozzle caps 16. As mentioned before, it will be appreciated that the exposed surface 46 and the tapered external face 50 are actually, integrated being one continuous surface. This continuous surface configured and angled such that it engages annular flange 32 and protrudes; through the spray opening 38 smoothly without being jammed or stuck. Also, the annular flange 32 is so designed and sized as to facilitate passing and protrusion of the protruding member 28 in its entirety beyond the planar spray opening 38. The distance between the planar spray opening 38 and the plateau 47 is indicated by the arrows C-C. This clearly illustrates that the orifice 44 (being an outlet in afunctional sense) is substantially distanced from and stands substantially proud of the planar spray opening 38.

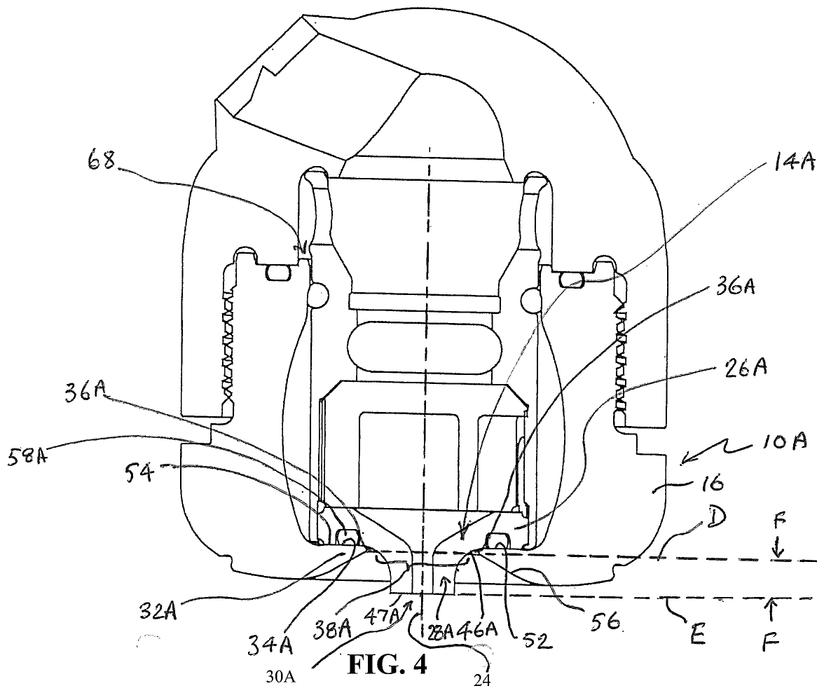

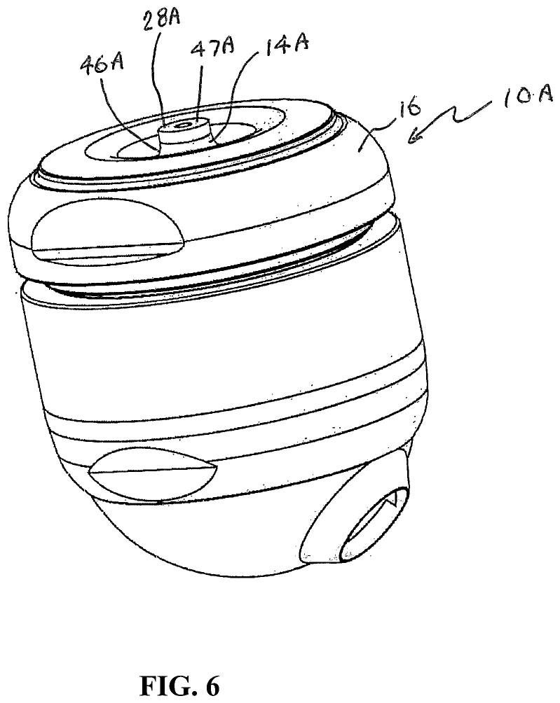

Turning to FIGS. 4, 5 and 6, in another preferred embodiment 14A of the insert, the interior locating surface 34A of the annular flange 32A is flush with the planar spray opening 38A which is on an imaginary plane D indicated by dotted line. The base member, being in the form of an annular disc 26A in this embodiment, is configured to provide an annular shoulder 52 with an external face 54 which in use abuts the interior locating surface 34A. In this embodiment, the exposed surface 46A converges curvedly to form a neck-shaped protruding member 28A. The exposed surface then reaches an annular plateau 47A indicated by a dotted line E. The spray nozzle 10A has a downstream end portion 30A with a smooth exterior contour which transitions from a curved exterior surface 56 of the annular flange 32A to the curved exposed surface 46A of the protruding member 28A a the extremity 36A in a seamless fashion. Again, the distance between the planar spray opening 38A and the plateau 47A is indicated by the arrows F-F. This clearly illustrates that the orifice 44 is substantially distanced from and stands substantially proud of the planar spray opening 38A.

Referring back to FIG. 1, the inclined external face 50 of the base member 26 has a groove 58 configured to receive a sealing means which is in the form of an O-ring 60. The counterbore 22 is defined by a cylindrical wall 62 which ends with a retaining lip 64 which acts as an impediment to keep the insert 14 in place. The spray nozzle 10 (and 10A) has a swirl unit 66 which is positioned upstream of the insert 14. The nozzle cap 16 has an upstream end 68 which in use is adapted to engage the fluid receiving section 18 of the nozzle body 12.

In both of the above described embodiments of the spray nozzle 10 & 10A, the nozzle cap 16 provides a mechanism for positively securing the insert 14 and swirl unit 66 in place and compresses the sealing means (ie. the O-ring) 60 as the upstream end 68 threadably engages the fluid receiving section 18 of the nozzle body 12. The arrangement is such that tightening of the nozzle cap 16 to the nozzle body 12 causes compressive sealing by the sealing means (ie. the O-ring) 60.

It should be noted that the insert 14 in the form of an orifice disc is a component which may require regular replacement and is typically manufactured of a hard-wearing material such as tungsten carbide or ceramic.

Now that preferred embodiments of the present invention have been described in some detail, it will be apparent to a skilled person in the art that the spray nozzle of the present invention may offer a least the following advantages:
1. it assists in the atomisation process by reducing build-up of spray splatter on the nozzle cap thereby allowing the drier to run on for longer and hence increasing productivity by minimising outages and downtimes;
2. the insert facilitates distancing of the nozzle orifice (ie. the outlet) from the spray opening defined by the nozzle cap resulting in the spray plume being further and substantially away from the nozzle cap thereby reducing the likelihood of any bunt particulate settling and accumulating on the nozzle end and the protruding member itself;
3. it minimises the development of scorched particles thereby improving the quality and hence value of the milk powder; and
4. it reduces the likelihood of formation of a burnt ignition source thereby reducing fire risk.

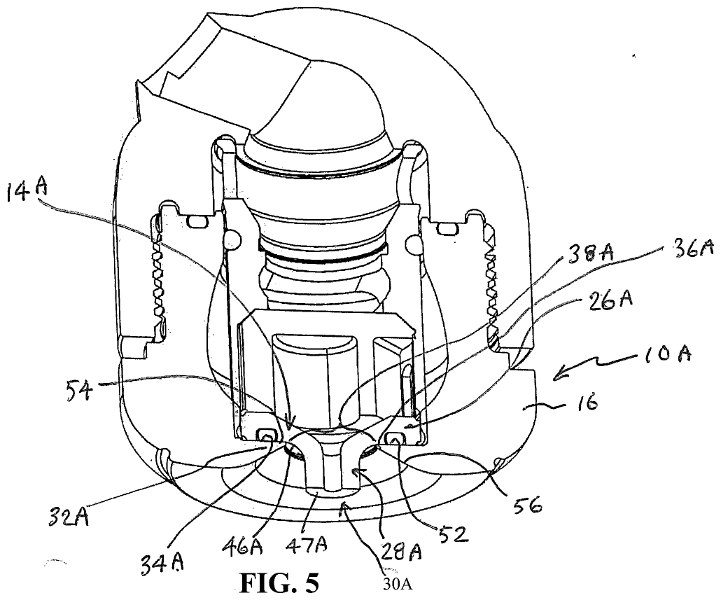

Those skilled in the art will appreciate that the invention described herein is susceptible to variations and modifications other than those specifically described. For instance, as shown in FIG. 1, the swirl unit 66 and the insert 14 are held in position by the nozzle body 12 which is also often referred to as the clasp. The body 12 or clasp with the retaining lip 64 offers the benefits of a) assisting to position and secure the insert 14 in place so as to facilitate aligned engagement of the insert 14 with nozzle cap 16. However, this body 12 or clasp may be omitted in a more economical arrangement as shown in the embodiment shown in FIG. 5 where the insert 14 and swirl unit 66 are simply keep in place against the nozzle cap 16 by a retainer provided in the vicinity of the upstream end of the nozzle cap 16. All such variations and modifications are to be considered within the scope and spirit of the present invention the nature of which is to be determined from the foregoing description.

It is to be understood that any acknowledgement of prior art in this specification is not an admission that this prior art forms part of the common general knowledge in the relevant art.

1.-27. (canceled)

28. A spray nozzle having a downstream end portion with a smooth exterior contour, the spray nozzle including:
a removable insert having a base member and a protruding member, the base member being integrated with the protruding member and having an external face;
a nozzle cap with an annular flange which delimits an interior locating surface for the insert, the flange extending radially and ending with an internal extremity which defines a planar spray opening; and
wherein the base member is housed within the nozzle cap whilst the protruding member projects outwardly, the protruding member stands entirely proud of the planar spray opening, the external face of the base member abutting the interior locating surface so as to form a tight seal between the annular flange and the removable insert, the smooth exterior contour transitions from the annular flange with an exterior surface which curves towards the extremity to the external face of the protruding member in a seamless fashion.

29. The spray nozzle of claim 28, which includes a nozzle body to which the nozzle cap is adapted to engage, the nozzle body having a fluid receiving section and a discharging section and defining a counterbore which extends between the fluid receiving section and the fluid discharging section and which delineates a central axis towards which the flange radially extends.

30. The spray nozzle of claim 28, wherein the protruding member includes a cylindrical wall which defines a passage which ends with an orifice.

31. The spray nozzle of claim 30, wherein the planar spray opening is on a plane which is substantially perpendicular to the passage.

32. The spray nozzle of claim 28, wherein the protruding member of the insert is adapted to be removably fitted into the spray opening.

33. The spray nozzle of claim 28, wherein the protruding member has an exposed surface which travels beyond the planar spray opening.

34. The spray nozzle of claim 33, wherein the exposed surface includes an annular plateau which surrounds an orifice.

35. The spray nozzle of claim 28, wherein an orifice is located at a distal end of the protruding member, the orifice is distanced from the planar spray opening.

36. The spray nozzle of claim 28, wherein the insert is in the form of a frustoconically shaped disc.

37. The spray nozzle of claim 33, wherein an exposed surface of the protruding member is linear and tapered, the exposed surface being inclined to the planar spray opening at a constant exposed surface angle.

38. The spray nozzle of claim 37, wherein the base member also has a tapered external surface which is linear and inclined to the planar spray opening at a constant external face angle, the constant external face angle being the same as the constant exposed surface angle.

39. The spray nozzle of claim 38, wherein the exposed surface and the tapered external surface are collinear and continuously integrated into one another.

40. The spray nozzle of claim 38, wherein the exposed surface and the tapered external surface are coplanar.

41. The spray nozzle of claim 38, wherein the interior locating surface of the annular flange is a slanting surface complementary to the tapered external face of the base member.

42. The spray nozzle of claim 38, wherein the tapered external face of the base member is capable of facilitating smooth insertion of the protruding member into the spray opening of the nozzle cap resulting in self-alignment or centering of the insert which is concentric or coaxial to the annular flange of the nozzle cap.

43. The spray nozzle of claim 28, wherein the interior locating surface of the annular flange is flush with the planar spray opening.

44. The spray nozzle of claim 28, wherein the base member provides an annular shoulder with an external face which in use abuts the interior locating surface.

45. The spray nozzle of claim 33, wherein the exposed surface converges curvedly to form a neck-shaped protruding member.

46. The spray nozzle of claim 28, wherein the external face of the base member includes a groove adapted to receive a sealing means.

47. The spray nozzle of claim 46, wherein the sealing means is an O-ring.

48. The spray nozzle of claim 28, wherein a counterbore of a nozzle body is defined by a cylindrical wall which ends with a retaining lip which acts as an impediment to keep the insert in place.

49. The spray nozzle of claim 28, which includes a swirl unit which is positioned upstream of the insert.

50. The spray nozzle of claim 49, wherein the nozzle cap has an upstream end which in use is adapted to engage a fluid receiving section of a nozzle body.

51. The spray nozzle of claim 50, wherein the nozzle cap provides a mechanism for positively securing the insert and swirl unit in place and compresses a sealing means as the nozzle cap threadably engages the fluid receiving section of the nozzle body.

52. A removable insert for fitting into a nozzle cap of a spray nozzle having a downstream end portion with a smooth exterior contour, the insert having a base member and a protruding member, the nozzle cap having an annular flange which delimits an interior locating surface for the insert, the flange extending radially and ending with an internal extremity which defines a planar spray opening; wherein the base member is housed within the nozzle cap whilst the protruding member projects outwardly, the protruding member stands entirely proud of the planar spray opening, the protruding member includes an exposed surface which travels beyond the planar spray opening, the exposed surface being either linear and inclined to the planar spraying opening at a constant angle or converging curvedly to form a neck-shaped protruding member, the exposed surface of the protruding member is adapted to transition to the annular flange having an exterior surface which curves towards the extremity in a seamless fashion so as to form the smooth exterior contour.
